(19) United States
(12) Patent Application Publication
(10) Pub. No.: US 2007/0031651 A1
(43) Pub. Date: Feb. 8, 2007

(54) Slide bearing for internal combustion engines

(75) Inventors: Yukihiko Kagohara, Inuyama (JP); Shinji Ochi, Inuyama (JP); Hideo Ishikawa, Inuyama (JP); Masaaki Sakamoto, Inuyama (JP)

Correspondence Address: BROWDY AND NEIMARK, P.L.L.C.;624 NINTH STREET, NW, SUITE 300, WASHINGTON, DC, 20001-5303, US

(73) Assignee: Daido Metal Company Ltd., Nagoya (JP)

(21) Appl. No.: 11/500,368

(22) Filed: Aug. 8, 2006

(30) Foreign Application Priority Data
Aug. 8, 2005 (JP) 2005-229473

(51) Int. Cl. B32B 5/16

(52) U.S. Cl. 428/323; 428/325; 384/913

(57) ABSTRACT

A slide bearing for internal combustion engines, comprising a slide layer including a lubricant outer layer in which a solid lubricant is contained, and wherein the lubricant outer layer contains an element which is contained in the solid lubricant, at a maximum concentration of not less than 5 mass % in the lubricant outer layer, and at least a solid lubricant gathered particle is formed on a surface of the lubricant outer layer, the solid lubricant gathered particle being a particle of the solid lubricant formed by gathering a plurality of primary particles, the solid lubricant gathered particle having a long side of not less than 20 μm but less than 100 μm in terms of surface visual field of the lubricant outer layer.

### BACKGROUND OF THE INVENTION

(1) Field of the Invention

The present invention relates to a slide bearing for internal combustion engines, which is favorably maintained in fatigue resistance, decreased in friction coefficient, and improved in anti-seizure property.

(2) Description of Related Art

Excellent anti-seizure property, fatigue resistance, and wear resistance are demanded of slide bearings used for internal combustion engines in automobiles and general industrial machinery. Conventional slide bearings for internal combustion engines include aluminum-based alloy bearings having a back metal layer lined with an aluminum alloy, copper-based alloy bearings having a back metal layer lined with a copper alloy, and bearings formed by applying an overlay on a surface of a copper-based alloy bearing. These bearings are properly used according to circumstances in use.

Recent internal combustion engines tend to become high in speed and output, light in weight, and saving in fuel consumption, and it is correspondingly desired that slide bearings be made further high in performance. However, an oil film on a whole bearing surface becomes thin when internal combustion engines become high in speed and output, and a bearing housing becomes susceptible to deformation due to lightening. As a result, local contact is liable to occur and an oil film becomes very thin, so that portions undergoing direct contact (metallic contact) increase which leads to extraordinary wear and seizure due to adhesion in some cases. In order to avoid this, conformability is demanded of slide bearings so as to ensure an oil film in an early stage and that property, in which seizure is not readily caused and fatigue is not caused in an early stage even in case of metallic contact, is demanded thereof.

In order to decrease shear force of a lubricating oil, a lubricating oil having a low viscosity is used as one of measures for saving fuel consumption. Therefore, an oil film becomes thin to increase portions undergoing metallic contact in the same manner as in the case where internal combustion engines become high in speed and output and light in weight. Such metallic contact portions are large in frictional resistance to a mating shaft, so that there is a possibility that it is not possible to contribute to saving fuel consumption, and heat is also generated by friction. Furthermore, the lubricating oil is decreased in viscosity by such heat, so that metallic contact is promoted. In order to prevent generation of heat, it is requested to decrease a friction coefficient to the mating shaft, and when the friction coefficient can be decreased, a heating value is not only decreased but also an improvement in anti-seizure property can be achieved.

While it is not relating to a slide bearing, WO 02/40743 discloses that a molybdenum disulfide containing layer is provided by striking minute powder of molybdenum disulfide (MoS₂) against a surface of a piston to thereby cause an outer layer within a depth of 20 μm from a surface to contain molybdenum disulfide being a solid lubricant in order to make a piston of an internal combustion engine small in frictional resistance.

### BRIEF SUMMARY OF THE INVENTION

In a well-known technology for slide bearings, a solid lubricant is blended in components of a bearing alloy, or a solid lubricant is coated together with a binder resin on a surface of a bearing alloy layer whereby a decrease in frictional resistance to a mating shaft is attained.

However, a method of coating a solid lubricant on a surface of a bearing alloy layer involves a problem in adhesive strength of a coating layer, and a sufficient friction coefficient decreasing effect cannot be in some cases produced due to the existence of the binder resin.

Furthermore, with reference to a method of blending a solid lubricant in components of a bearing alloy, for aluminum-based alloys, solid lubricant particles are generally blended in aluminum-based alloy particles. Thereby, a solid lubricant can be contained in an aluminum-based alloy. However, strength becomes low because of powder metallurgical particles, and thus the alloy is not fit for use as slide bearings for internal combustion engines. In the case where a bearing alloy is a copper-based alloy, solid lubricant particles are mixed with main raw material of copper-based alloy particles, then they are sintered to manufacture a product. However, the solid lubricant is thermally decomposed in manufacturing, and so it is difficult to have the solid lubricant contained in the alloy.

Hereupon, it is conceivable to apply the technology described in WO 02/40743 to a slide bearing for internal combustion engines to form a molybdenum disulfide containing layer on a surface of a bearing alloy layer. The technology described in WO 02/40743 comprises striking minute powder of molybdenum disulfide against a surface of a piston to thereby form a molybdenum disulfide containing layer on an outer layer within a depth of 20 μm and to form minute dimples on the surface of the piston, thus achieving reduction in friction owing to a lubricating effect of molybdenum disulfide itself and an oil storing effect of the dimples on the surface. Also, since minute powder of molybdenum disulfide is struck against the surface of the piston at high speed, the piston is increased in surface temperature to an extent, in which a part of the piston melts to form an intermetallic compound with molybdenum in the molybdenum disulfide, so that the molybdenum disulfide is heightened in strength of adhesion and the surface causes work hardening to be improved in wear resistance.

However, the piston is made of an aluminum-based alloy, which is hard to have a Vickers hardness of not less than 300. On the other hand, the inventors of the present application have confirmed through experiments that since a bearing alloy is soft unlike a piston, it is increased in surface roughness when minute powder of a solid lubricant is caused to strike against it, and dimples on its surface become large and irregular in shape, so that oil film breakage rather than an oil storing effect is caused due to the existence of the dimples, whereby heat is generated to cause damages to anti-seizure property and fatigue resistance.

The invention has been thought of in view of the situation and has its object to provide a slide bearing for internal combustion engines, a slide layer of which is not increased in surface roughness and can be provided with a lubricant outer layer (or region) in which a solid lubricant is contained, whereby the slide bearing is maintained in fatigue resistance, low in friction coefficient, and excellent in anti-seizure property.

The invention provides a slide bearing for internal combustion engines, comprising a slide layer including a lubricant outer layer (or region) in which a solid lubricant is contained, wherein the lubricant outer layer contains an element which is contained in the solid lubricant, at a maximum concentration of not less than 5 mass %, and at least a solid lubricant gathered particle is formed on a surface of the lubricant outer layer, the solid lubricant gathered particle being a particle of the solid lubricant formed by gathering a plurality of primary particles, the solid lubricant gathered particle having a long side of not less than 20 μm but less than 100 μm in terms of surface visual field (that is, observed from a surface) of the lubricant outer layer.

In internal combustion engines, an oil film formed between a slide bearing surface and a mating shaft tends to become thin due to misalignment in an early stage of an internal combustion engine and high speed rotation or a rapid change in rotation in steady-state operation. Under such condition, a surface of the slide bearing comes into metallic contact with a mating shaft to suitably undergo deformation and abrasion. That is, a surface of a slide bearing has the function of suitably undergoing deformation and abrasion to ensure an oil film to bear an oil film pressure generated upon operation of an internal combustion engine to assure a normal operation of the internal combustion engine.

When a slide bearing comes into metallic contact with a mating shaft, an increase in frictional resistance is caused as compared with a state of fluid lubrication in which an oil film is ensured. An associated contact portion generates heat, and in some cases, such generated heat causes a bearing surface material to be decreased in strength whereby the bearing surface material increasingly adheres to the mating shaft to cause seizure.

A slide bearing according to the invention comprises a slide layer including a lubricant outer layer in which a solid lubricant is contained. The solid lubricant possesses a self-lubricating property to exhibit a low friction coefficient. Accordingly, with the slide bearing according to the invention, the presence of the lubricant outer layer makes it possible to prevent an increase in frictional resistance, which is caused by direct contact. Therefore, a decrease in material strength due to generation of heat is suppressed, which is advantageous to anti-seizure property.

When an element contained in a solid lubricant has a maximum concentration of not less than 5 mass % (in the case where a plurality of kinds of solid lubricants are present, a total of elements contained in the respective solid lubricants has a maximum concentration of not less than 5 mass %), it is possible to produce a friction coefficient decreasing effect. Preferably, the maximum concentration is not less than 15 mass %. Here, an element contained in a solid lubricant indicates a single element which forms the solid lubricant, in case where the solid lubricant is composed of the single element. In case where the solid lubricant is composed of two or more elements, an element contained in a solid lubricant indicates an element having a maximum atomic weight among the elements which form the solid lubricant. A maximum concentration of an element contained in a solid lubricant indicates a maximum one among those concentrations of elements, which are measured every divided unit when a lubricant outer layer is divided into a multiplicity of layers each having a predetermined thickness.

It is possible in the invention to use, for example, an aluminum-based alloy bearing, a copper-based alloy bearing, and an overlaid copper-based alloy bearing. An aluminum-based alloy bearing and a copper-based alloy bearing comprise a slide bearing having a configuration in which a bearing alloy layer 2 composed of an aluminum-based bearing alloy or a copper-based bearing alloy is lined on a back metal layer 1 as shown in FIG. 1. The aluminum-based bearing alloy can be provided by adding 3 to 20 mass % of tin; 1.5 to 8 mass % of silicon; and copper, zinc, magnesium, manganese, vanadium, molybdenum, chromium, nickel, cobalt, tungsten, etc., which serve as an element for improvement in fatigue resistance, to aluminum, and has a Vickers hardness in a range of about 40 to about 80. Also, the copper-based bearing alloy can be provided by adding tin, nickel, etc. to copper, and has a Vickers hardness in a range of about 80 to about 150. The overlaid copper-based bearing alloy is provided by using electroplating to adhere an overlay 3, which is composed of lead alloy, tin alloy, bismuth alloy, etc., to a surface of a bearing alloy layer 2, which is composed of a copper-based bearing alloy, as shown in FIG. 2. The overlay 3 uses a relatively soft metal such as lead alloy, etc. to have a Vickers hardness in a range of about 10 to about 30. In addition, the overlay is normally formed to have a thickness of about 15 μm.

In such slide bearing shown in FIG. 1, the bearing alloy layer 2 serves as a slide layer 6, and in such slide bearing shown in FIG. 2, the bearing alloy layer 2 together with the overlay 3 serves as a slide layer 6. In a method of having a solid lubricant contained in an outer layer of a slide layer to form a lubricant outer layer, it is conceivable to apply a so-called shot peening technique of striking particles 4 of a solid lubricant against a surface of the slide layer 6. As a solid lubricant for shot peening, it is possible to use one or more of molybdenum disulfide, graphite, tungsten disulfide, h-boron nitride, graphite fluoride, and molybdenum trioxide.

Particles 4 of a solid lubricant include a particle of a solid lubricant, which is composed of a single particle substance (primary particle), and a particle of a solid lubricant which a plurality of primary particles gather to form. When these particles 4 of a solid lubricant are caused to strike against a slide layer surface 8 of a slide bearing, the particles 4 of the solid lubricant enter a surface portion of the slide layer 6 to form a lubricant outer layer (or region) 5. When the particles 4 of the solid lubricant strike against the slide layer surface 8, a particle of a solid lubricant, which a plurality of primary particle gather to form, is crushed flat by a shock at the time of collision. In particular, when a particle (secondary particle) of a solid lubricant, which a plurality of primary particles gather to form, is referred to in the following descriptions, it is called a solid lubricant gathered particle. Since a plurality of primary particles cohere due to a force comparable to an intermolecular force to form a solid lubricant gathered particle, the solid lubricant gathered particle is small in strength as compared with primary particles. Therefore, even when solid lubricant gathered particles are projected, a projected surface is not made rough (a surface of large surface roughness is not made).

According to the invention, the solid lubricant gathered particle sized to be not less than 20 μm but less than 100 μm in terms of surface visual field is present on a surface of a lubricant outer layer 5, as shown in FIG. 3B. Here, dimensions of the solid lubricant gathered particle are represented by a length of a long side thereof (a maximum diameter). Of course, particles 4 of a solid lubricant, which are composed of primary particles, may be present on the surface of the lubricant outer layer 5.

Solid lubricant gathered particles sized to be not less than 20 μm but less than 100 μm are present on a surface of a slide layer (an outer surface of the lubricant outer layer) whereby a decrease in frictional resistance can be achieved. In direct contact with a mating shaft, a solid lubricant is supplied to the surface of the slide layer from a lubricant outer layer or solid lubricant gathered particles whereby a decrease in frictional resistance is achieved. In some cases, only solid lubricant gathered particles sized to be less than 20 μm results in shortage in feed rate, and in case of not less than 100 μm, solid lubricant gathered particles themselves peel off or come off a lubricant outer layer. Preferably, solid lubricant gathered particles are sized to be 20 to 50 μm. The solid lubricant gathered particles sized to be not less than 20 μm but less than 100 μm are further effective for a decrease in friction coefficient when not less than 5 but less than 40 of them are present per 4.5 mm². Not less than 30 but not more than 200 is preferable.

As described above, a surface of a slide bearing suitably undergoes wear to ensure an oil film. In order to keep an operation with solid lubrication taking into consideration of keeping an abrasion throughout a service life of an internal combustion engine, a lubricant outer layer containing a solid lubricant is preferably present within a depth of 10 μm from a surface of a bearing alloy layer. When the depth exceeds 10 μm, the bearing alloy layer is decreased in strength to lead to fatigue due to an oil film pressure. Not more than 5 μm is more preferable.

Due to collision against a slide layer at the time of shot peening, solid lubricant gathered particles are crushed flat. The solid lubricant gathered particles are in some cases embedded fully in the lubricant outer layer 5 and partially embedded to partially project from a surface of the lubricant outer layer 5 as shown in FIG. 3A. In the case where a dimension T in a thickness direction is, for example, 15 μm and a solid lubricant gathered particle is partially embedded in the lubricant outer layer 5, the dimension is composed of an embedment depth 10 μm and a height 5 μm, by which the particle projects from the surface of the lubricant outer layer 5. In the case where a dimension in a thickness direction is not more than 15 μm, it is easy to make an embedment depth not more than 10 μm, so that a solid lubrication effect is readily produced while a bearing alloy is maintained in strength, and it is easy to make a projection height not more than 5 μm, so that oil film breakage caused by roughness is readily prevented. In case of a thickness being not less than 0.01 μm, an improvement in supplying a solid lubricant to the surface of the lubricant outer layer 5 is achieved to enable a further decrease in friction coefficient. Accordingly, the solid lubricant gathered particles preferably have a dimension of 0.01 to 15 μm in a thickness direction. 1 to 10 μm is more preferable.

In case of forming a lubricant outer layer on a bearing alloy layer, the bearing alloy preferably has a Vickers hardness of not more than 160. In the case where the bearing alloy has a Vickers hardness of more than 160, high energy (collision speed, particle mass) becomes necessary to have a solid lubricant contained in a bearing alloy layer with the result that dimples are generated on a surface thereof and an increase in surface roughness is caused by melting. When a bearing alloy layer has a Vickers hardness of less than 40, it cannot withstand a load as a bearing for internal combustion engines, of which high speed and high output are requested. Therefore, a bearing alloy layer preferably has a Vickers hardness of not less than 40 but less than 160.

In case of forming a lubricant outer layer on an overlay, the overlay is soft, so that collision energy of a solid lubricant is reduced so as not to generate dimples.

With both a configuration in which a lubricant outer layer is formed on a bearing alloy layer, and a configuration in which a lubricant outer layer is formed on an overlay, it is possible that in case of shot peening of minute particles of a solid lubricant, dimples be generated on a surface of the lubricant outer layer to result in an increase in surface roughness. The roughness preferably has a maximum height Rz of not more than 5 μm in terms of prevention of oil film breakage. This is preferable as well for a friction coefficient and an anti-seizure property. A surface roughness of not more than 3 μm is more preferable.

According to the invention, a surface covering layer composed of a solid lubricant and having a thickness of 0.01 to 10 μm can be provided on the surface of the lubricant outer layer. The surface covering layer can be formed by decreasing collision energy of a solid lubricant. When the collision energy is decreased, solid lubricants themselves join due to an intermolecular force to adhere as a layer to the surface of the lubricant outer layer.

Since the surface covering layer is formed from only a solid lubricant, it is possible to heighten a self-lubricating property. In the case where the surface covering layer has a thickness of less than 0.01 μm, there is produced the same effect as the case where not less than 5 mass % of an element contained in a solid lubricant is contained within a depth of 10 μm from a surface of a bearing alloy layer. Also, when the surface covering layer has a thickness of more than 10 μm, it becomes liable to peel off a bearing alloy layer. The surface covering layer more preferably has a thickness of 0.1 to 5 μm.

### BRIEF DESCRIPTION OF THE SEVERAL VIEWS OF THE DRAWINGS

FIG. 1 is a cross sectional view conceptually showing a lubricant outer layer of a slide layer (without any overlay) according to the invention;

FIG. 2 is a cross sectional view conceptually showing a lubricant outer layer of a slide layer (with an overlay) according to the invention;

FIG. 3A is a cross sectional view showing a state, in which solid lubricant particles are embedded in a lubricant outer layer;

FIG. 3B is a plan view showing a state, in which the solid lubricant particles are embedded in the lubricant outer layer;

FIG. 4A is a graph illustrating results of static friction coefficient measuring tests for aluminum-based alloy bearings (a slide layer of which is made of Al-10Sn-3Si-1Cu);

FIG. 4B is a graph illustrating results of seizure tests for aluminum-based alloy bearings (a slide layer of which is made of Al-10Sn-3Si-1Cu);

FIG. 4C is a graph illustrating results of fatigue tests for aluminum-based alloy bearings (a slide layer of which is made of Al-10Sn-3Si-1Cu);

FIG. 5A is a graph illustrating results of static friction coefficient measuring tests for copper-based alloy bearings (a slide layer of which is made of Cu-10Sn);

FIG. 5B is a graph illustrating results of seizure tests for copper-based alloy bearings (a slide layer of which is made of Cu-10Sn);

FIG. 5C is a graph illustrating results of fatigue tests for copper-based alloy bearings (a slide layer of which is made of Cu-10Sn);

FIG. 6A is a graph illustrating results of static friction coefficient measuring tests for overlaid copper-based alloy bearings (of which a slide layer is made of Pb-9Sn-9In);

FIG. 6B is a graph illustrating results of seizure tests for overlaid copper-based alloy bearings (of which a slide layer is made of Pb-9Sn-9In); and

FIG. 6C is a graph illustrating results of fatigue tests for overlaid copper-based alloy bearings (of which a slide layer is made of Pb-9Sn-9In).

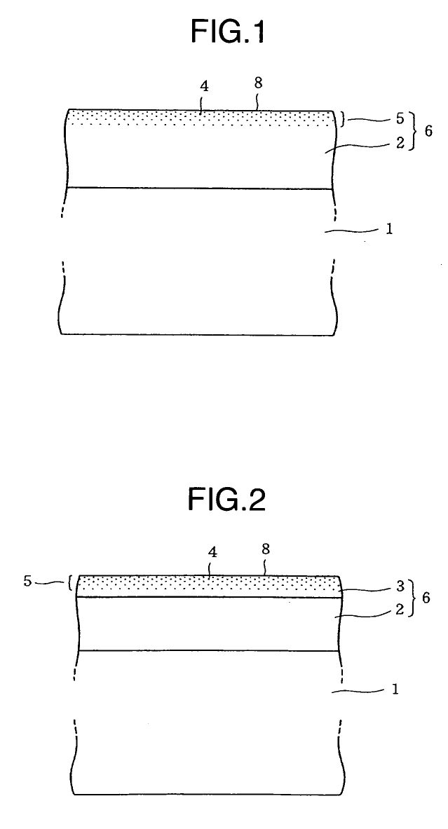

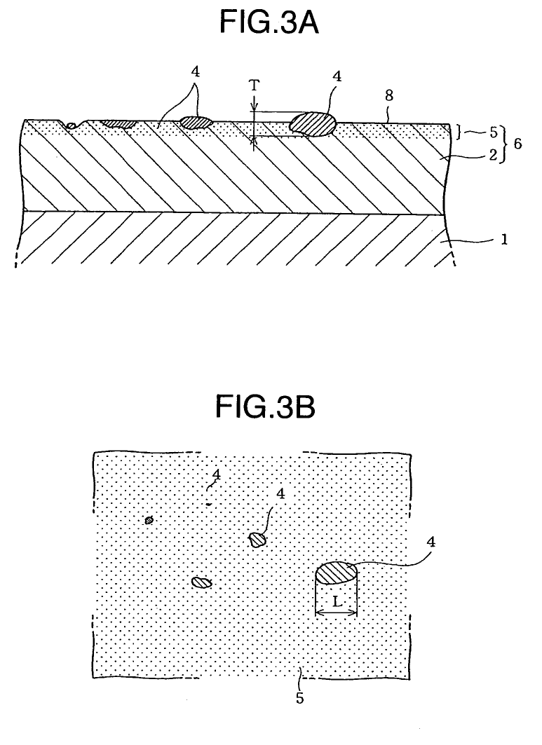

### DETAILED DESCRIPTION OF THE INVENTION

Subsequently, the invention will be described in further detail with reference to a specific embodiment.

(1) First, a method of manufacturing a slide bearing will be described with respect to an aluminum-based alloy bearing, a copper-based alloy bearing, and an overlaid copper-based alloy bearing.

<Aluminum-Based Alloy Bearing>

Bimetal, which makes a material of a bearing, is manufactured by forming an aluminum-based bearing alloy plate for a bearing alloy layer by means of normal casting and rolling, and overlapping the plate on a low carbon steel strip which forms a back metal layer, to subject the same to roll bonding. A slide bearing is fabricated by working the bimetal into a semi-cylindrical shape.

<Copper-Based Alloy Bearing>

Bimetal is manufactured by spreading copper-based bearing alloy powder on the low carbon steel strip which forms a back metal layer, to subject the same to sintering at high temperature. A slide bearing is fabricated by working the bimetal into a semi-cylindrical shape.

<Overlaid Copper-Based Alloy Bearing>

Electroplating is used to apply metallic overlay to an inner surface of the copper-based alloy bearing as fabricated in the above manner.

(2) Subsequently, a method of forming a lubricant outer layer will be described.

The lubricant outer layer is formed by having a solid lubricant contained in a surface of a slide layer of the slide bearing as fabricated in the above manner. In order to do this, a solid lubricant powder which has a particle size of 0.5 to 80 μm is projected by a compressed air at 0.5 to 1.0 MPa onto the surface of the slide layer of the slide bearing as fabricated above to make the solid lubricant present in the slide layer.

In this case, the projected powder is composed of primary particles, and particles (solid lubricant gathered particles) which a multiplicity of primary particles gather to form. It is desired that the primary particles have a particle size of 0.5 to 20 μm and the solid lubricant gathered particles have a particle size of 20 to 80 μm and amount up to 70 vol. % of whole particles of the solid lubricant. More desirably, the solid lubricant gathered particles amount up to 5 to 30 vol. % of the whole particles.

In addition, after the lubricant outer layer is formed, a surface covering layer composed of a solid lubricant may be provided on a surface of the lubricant outer layer.

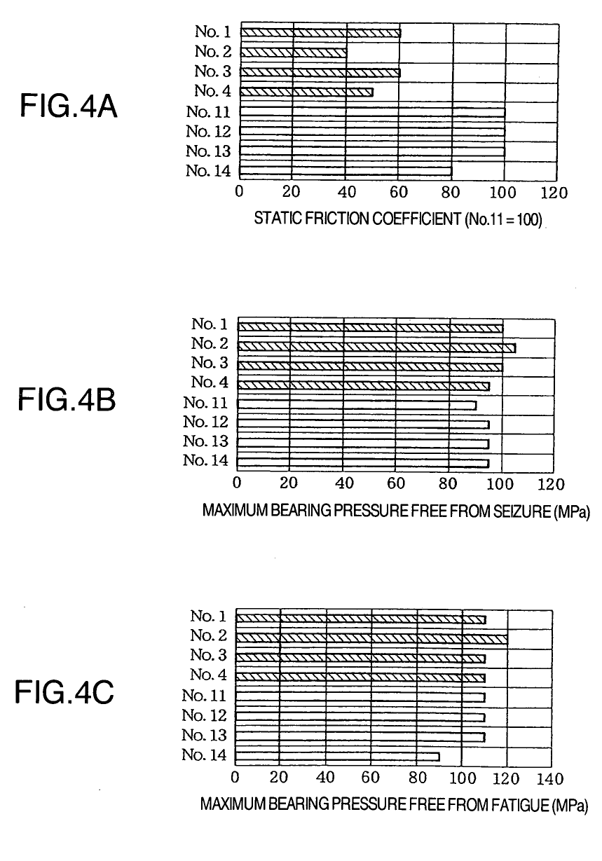

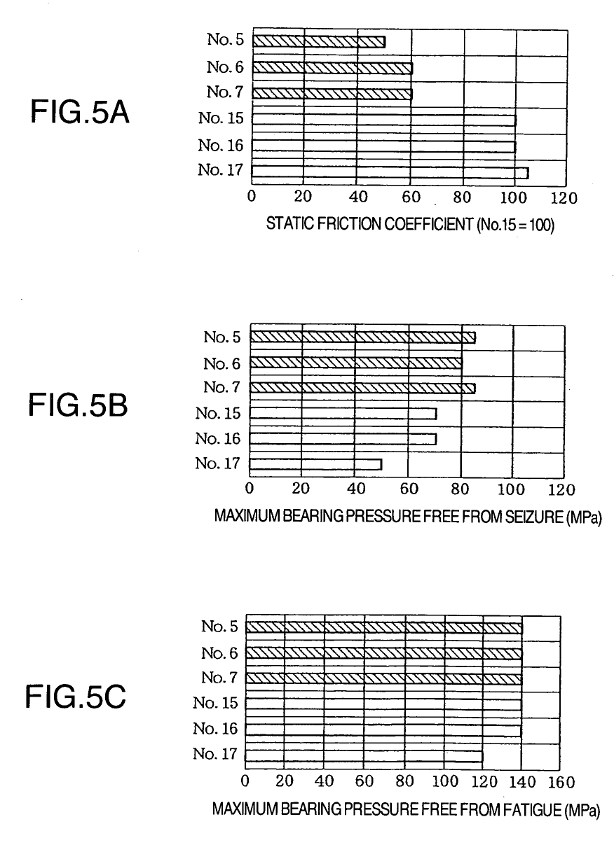

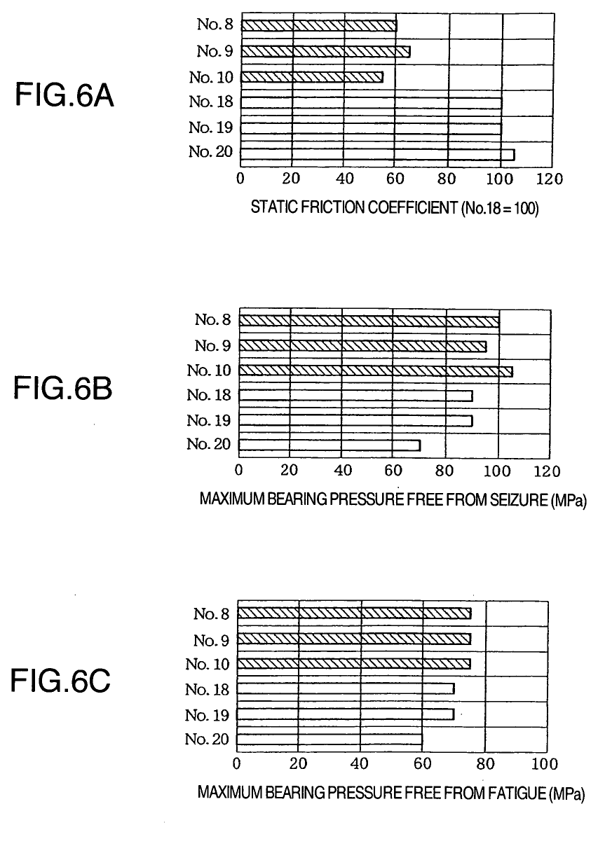

(3) According to the method described above, invention samples and comparative samples indicated in the following TABLES 1 to 3 were fabricated and performance tests were taken thereof. TABLE 1 indicates aluminum-based alloy bearings, a bearing alloy layer of which is composed of Al-10Sn-3Si-1Cu (the numerals represent contents in mass %. The same applies to the following), TABLE 2 indicates copper-based alloy bearings, a bearing alloy layer of which is composed of Cu-10Sn, and TABLE 3 indicates overlaid copper-based alloy bearings, a bearing alloy layer of which is obtained by covering a copper-based bearing alloy, which has the same components as those in TABLE 2, with an overlay composed of Pb-9Sn-9In. In addition, all the samples indicated in TABLES 1 to 3 are provided with no surface covering layer. Also, according to GDOES (glow discharge optical emission spectroscopy), a concentration of an element contained in a solid lubricant on the lubricant outer layer was measured. In the performance tests, static friction coefficient measuring tests, seizure tests, and fatigue tests were carried on, TABLES 4 to 6 indicate test conditions thereof, and FIGS. 4 to 6 indicate respective test results. The static friction coefficient measuring tests are indicated assuming that comparative products 11, 15, 18 containing no solid lubricant have a friction coefficient of 100.

TABLE 1
BEARING ALLOY LAYER BEING SLIDE LAYER AND
FORMED OF MATERIAL OF Al—10Sn—3Si—1Cu (MASS %)

| | | MAXIMUM | | LONG SIDE | NUMBER OF | | |
|---|---|---|---|---|---|---|---|
| | | CONCENTRATION | DEPTH OF | OF SOLID | SOLID | BEARING | |
| | SAM- | OF SOLID | LUBRICANT | LUBRICANT | LUBRICANT | SURFACE | KIND OF |
| | PLE | LUBRICANT | OUTER LAYER | PARTICLES | PARTICLES/ | ROUGHNESS | SOLID |
| | No. | MASS % | μm | μm | 4.5 mm² | Rz, μm | LUBRICANT |
| INVENTION | 1 | 16.1 (Mo) | 1.3 | 20 | 15 | 1.56 | MoS2 |
| PRODUCT | 2 | 34.4 (W) | 2.7 | 70 | 200 | 2.24 | WS2 |
| | 3 | 9.5 (Mo) | 0.8 | 25 | 27 | 1.18 | MoS2 |
| | 4 | 18.2 (C) | 2.0 | 50 | 70 | 4.0 | Gr |
| COMPARATIVE | 11 | — | — | — | — | 1.60 | — |
| PRODUCT | 12 | 4.3 (Mo) | 1.2 | 0.5 | 16 | 1.51 | MoS2 |
| | 13 | 4.3 (W) | 2.5 | 0.5 | 420 | 2.17 | WS2 |
| | 14 | 10.8 (Mo) | 13 | 120 | 30 | 1.33 | MOS2 |

TABLE 2
BEARING ALLOY LAYER BEING SLIDE LAYER AND FORMED OF MATERIAL OF Cu—10Sn (MASS %)

| | | MAXIMUM | | LONG SIDE | NUMBER OF | | |
|---|---|---|---|---|---|---|---|
| | | CONCENTRATION | DEPTH OF | OF SOLID | SOLID | BEARING | |
| | SAM- | OF SOLID | LUBRICANT | LUBRICANT | LUBRICANT | SURFACE | KIND OF |
| | PLE | LUBRICANT | OUTER LAYER | PARTICLES | PARTICLES/ | ROUGHNESS | SOLID |
| | No. | MASS % | μm | μm | 4.5 mm² | Rz, μm | LUBRICANT |
| INVENTION | 5 | 30.5 (W) | 2.5 | 21 | 220 | 3.11 | WS2 |
| PRODUCT | 6 | 8.3 (Mo) | 1.0 | 33 | 80 | 1.21 | MoS2 |
| | 7 | 17.7 (C) | 1.1 | 65 | 17 | 2.76 | Gr |
| COMPARATIVE | 15 | — | — | — | — | 1.28 | — |
| PRODUCT | 16 | 2.7 (Mo) | 0.9 | 0.5 | 78 | 1.19 | MoS2 |
| | 17 | 3.8 (C) | 17 | 130 | 28 | 6.2 | Gr |

TABLE 3
OVERLAY BEING SLIDE LAYER AND FORMED OF MATERIAL OF Pb—9Sn—9In (MASS %)

| | | MAXIMUM | | LONG SIDE | NUMBER OF | | |
|---|---|---|---|---|---|---|---|
| | | CONCENTRATION | DEPTH OF | OF SOLID | SOLID | BEARING | |
| | SAM- | OF SOLID | LUBRICANT | LUBRICANT | LUBRICANT | SURFACE | KIND OF |
| | PLE | LUBRICANT | OUTER LAYER | PARTICLES | PARTICLES/ | ROUGHNESS | SOLID |
| | No. | MASS % | μm | μm | 4.5 mm² | Rz, μm | LUBRICANT |
| INVENTION | 8 | 24.9 (Mo) | 6.2 | 40 | 50 | 2.39 | MoS2 |
| PRODUCT | 9 | 7.8 (Mo) | 4.0 | 52 | 82 | 1.21 | MoS2 |
| | 10 | 28.9 (W) | 1.9 | 22 | 180 | 1.72 | WS2 |
| COMPARATIVE | 18 | — | — | — | — | 2.28 | — |
| PRODUCT | 19 | 3.8 (Mo) | 4.3 | 0.2 | 78 | 1.19 | MoS2 |
| | 20 | 34.0 (W) | 17 | 150 | 2 | 5.2 | WS2 |

TABLE 4

| | CONDITION |
|---|---|
| PERIPHERAL SPEED | 1.0 m/s (STARTING · STOPPING 1 CYCLE 4s) |
| LUBRICATING OIL | VG22 |
| OIL FLOW | 2 cc/min. |
| SHAFT MATERIAL | S55C |
| EVALUATION | MEASURE STARTING FRICTION |
| METHOD | COEFFICIENT AFTER 1 HOUR |
| TEST BEARING | 4 MPa |

TABLE 5

| | CONDITION |
|---|---|
| PERIPHERAL SPEED | 20 m/s |
| TEST BEARING | INCREASE 10 MPa BY 10 MPa EVERY 10 |
| | MINUTES |
| LUBRICATING OIL | VG22 |
| OILING TEMPERATURE | 100° C. |
| OIL FLOW | 150 cc/min. |
| SHAFT MATERIAL | S55C |
| EVALUATION METHOD | MAXIMUM BEARING PRESSURE FREE |
| | FROM SEIZURE |

TABLE 6

| | CONDITION |
|---|---|
| PERIPHERAL SPEED | 9.0 m/s |
| TEST TIME | 20 HOURS |
| LUBRICATING OIL | VG68 |
| OILING TEMPERATURE | 100° C. |
| OILING PRESSURE | 0.49 MPa |
| SHAFT MATERIAL | S55C |
| TEST BEARING | MAXIMUM BEARING PRESSURE FREE |
| | FROM FATIGUE |

(3-1) Results of tests for aluminum-based alloy bearings (TABLE 1) will be explained.

<Static Friction Coefficient Measuring Test>

All invention products 1 to 4, in which an element contained in a solid lubricant in a lubricant outer layer has a maximum concentration (a maximum concentration of an element of the solid lubricant) of not less than 5 mass % and a long side (a long side of solid lubricant particles) of solid lubricant gathered particles is not less than 20 μm but less than 100 μm, are decreased in friction coefficient as compared with a comparative product 11 with no lubricant outer layer and comparative products 12 to 14 which include an outer layer containing a solid lubricant but in which a maximum concentration of an element of a solid lubricant or a long side of solid lubricant particles is outside the range of the invention.

Paying attention to a particle size of solid lubricant particles, the comparative product 14 does not produce a friction coefficient decreasing effect comparable to that of the invention products 1 to 4 since a long side of solid lubricant particles is as large as 120 μm although an element of a solid lubricant has a maximum concentration of not less than 5 mass %. The reason for this is that when solid lubricant gathered particles are large in particle size to exceed 100 μm, they peel off in an early stage and a friction coefficient decreasing effect of a solid lubricant cannot be expected.

Also, although the number of solid lubricant gathered particles (the number of solid lubricant particles) of the invention product 1 is as relatively small as 15 per 4.5 mm², the invention product is decreased in friction coefficient as compared with the comparative products 12 to 14. In particular, the invention product 2, in which solid lubricant particles are many in number, is highest in friction coefficient decreasing effect among the invention products, which is partially because an element of a solid lubricant has a maximum concentration of as much as 34.4 mass %.

<Seizure Test, Fatigue Test>

All the invention products 1 to 4 exhibit an anti-seizure property and a fatigue resistance, which are equivalent to or more than those of the comparative products 11 to 14.

The invention product 2, in which an element of a solid lubricant has a maximum concentration of not less than 5 mass %, a long side of solid lubricant particles is not less than 20 μm but less than 100 μm, and the number of solid lubricant particles is 5 to 400/4.5 mm², is improved in anti-seizure property and fatigue resistance as compared with the comparative products 11 to 14. This is because a frictional resistance to a shaft was decreased and temperature rise of a surface of a slide layer was suppressed at the time of boundary lubrication in tests.

Making a comparison between the invention products 1 to 4 and the comparative product 14, the comparative product 14 is lowest in fatigue resistance in results of all the tests. The reason for this is that since the surface of comparative product 14 includes large solid lubricant gathered particles, a decrease in friction coefficient is not achieved due to generation of peeling-off of solid lubricant gathered particles and a lubricant outer layer is large in depth to decrease the slide layer in strength.

(3-2) Subsequently, test results of copper-based alloy bearings (TABLE 2) will be described.

<Static Friction Coefficient Measuring Test>

All invention products 5 to 7 are decreased in friction coefficient as compared with a comparative product 15 with no lubricant outer layer, and comparative products 16, 17, which include an outer layer containing a solid lubricant but in which a maximum concentration of an element of a solid lubricant is outside the range of the invention.

The invention product 6 having a lubricant outer layer, in which an element of a solid lubricant has a maximum concentration of not less than 5 mass % and a long side of solid lubricant particles is not less than 20 μm but less than 100 μm, is small in maximum concentration of an element of a solid lubricant as compared with the other invention products 5, 7 but is decreased in friction coefficient as compared with a comparative product 16, in which a long side of solid lubricant gathered particles is as small as 0.5 μm, and a comparative product 17, in which a long side of solid lubricant gathered particles is as large as 130 μm.

Making a comparison between the invention products 5 to 7 and the comparative product 17, since the comparative product 17, in which an element of a solid lubricant has a maximum concentration of less than 5 mass %, and a long side of solid lubricant gathered particles exceeds 100 μm, and surface roughness Rz of which exceeds 5 μm, is large in surface roughness, direct contact thereof with a shaft becomes excessive, frictional resistance cannot be decreased, and solid lubricant gathered particles peel off in sliding, so that a friction coefficient decreasing effect comparable to that of the invention products 5 to 7 is not obtained.

<Seizure Test, Fatigue Test>

All the invention products 5 to 7 are also more excellent in anti-seizure property than the comparative products 15 to 17. The invention products 5 to 7 are equivalent to or more in fatigue resistance than the comparative products 15 to 17.

In particular, the comparative product 17 is bad in anti-seizure property and fatigue resistance since solid lubricant particles are large in particle size to peel off.

(3-3) From results of static friction coefficient measuring tests, seizure tests, and fatigue tests for overlaid copper-based alloy bearings (TABLE 3), all invention products 8 to 10 also exhibit a large friction coefficient decreasing effect as compared with comparative products 18 to 20 and are superior in anti-seizure property and fatigue resistance thereto. The invention products 8 to 10 are bearings formed by providing an overlay on a surface of a bearing alloy layer of a copper-based alloy bearing, and specifically improved in anti-seizure property due to the provision of an overlay.

(3-4) As described above, it is possible according to the embodiment of the invention to obtain a slide bearing for internal combustion engines, which is improved in fatigue resistance, low in friction coefficient, and excellent in anti-seizure property.

1. A slide bearing for internal combustion engines, comprising a slide layer including a lubricant outer layer containing a solid lubricant,
wherein the lubricant outer layer contains an element contained in the solid lubricant, at a maximum concentration of not less than 5 mass %, and
at least a solid lubricant gathered particle is formed on a surface of the lubricant outer layer, the solid lubricant gathered particle being a particle of the solid lubricant formed by gathering a plurality of primary particles, the solid lubricant gathered particle having a long side of not less than 20 μm but less than 100 μm in terms of surface visual field of the lubricant outer layer.

2. The bearing according to claim 1, wherein the lubricant outer layer is formed to contain a solid lubricant within a depth of 10 μm from a surface of the slide layer.

3. The bearing according to claim 1, wherein solid lubricant gathered particles of not less than 20 μm but less than 100 μm are present, on the surface of the lubricant outer layer, in not less than 5 but less than 400 in number per 4.5 mm² in terms of surface visual field.

4. The bearing according to claim 1, wherein the lubricant outer layer has a surface roughness of not more than 5 μm in terms of surface roughness in maximum height Rz.

5. The bearing according to claim 1, wherein the solid lubricant is composed of one or more of molybdenum disulfide, graphite, tungsten disulfide, h-boron nitride, graphite fluoride, and molybdenum trioxide.

6. The bearing according to claim 1, wherein the solid lubricant gathered particle of not less than 20 μm but less than 100 μm on the surface of the lubricant outer layer is sized to be 0.01 to 15 μm in a thickness direction of the lubricant outer layer.

7. The bearing according to claim 1, further comprising a surface covering layer provided on the surface of the lubricant outer layer, the surface covering layer being composed of a solid lubricant and having a thickness of 0.01 to 10 μm.

8. The bearing according to claim 2, wherein solid lubricant gathered particles of not less than 20 μm but less than 100 μm are present, on the surface of the lubricant outer layer, in not less than 5 but less than 400 in number per 4.5 mm² in terms of surface visual field.

9. The bearing according to claim 8, wherein the lubricant outer layer has a surface roughness of not more than 5 μm in terms of surface roughness in maximum height Rz.

10. The bearing according to claim 8, wherein the solid lubricant gathered particle of not less than 20 μm but less than 100 μm on the surface of the lubricant outer layer is sized to be 0.01 to 15 μm in a thickness direction of the lubricant outer layer.

11. The bearing according to claim 2, wherein the lubricant outer layer has a surface roughness of not more than 5 μm in terms of surface roughness in maximum height Rz.

12. The bearing according to claim 2, wherein the solid lubricant gathered particle of not less than 20 μm but less than 100 μm on the surface of the lubricant outer layer is sized to be 0.01 to 15 μm in a thickness direction of the lubricant outer layer.

13. The bearing according to claim 3, wherein the lubricant outer layer has a surface roughness of not more than 5 μm in terms of surface roughness in maximum height Rz.

14. The bearing according to claim 3, wherein the solid lubricant gathered particle of not less than 20 μm but less than 100 μm on the surface of the lubricant outer layer is sized to be 0.01 to 15 μm in a thickness direction of the lubricant outer layer.
